(19) United States
(12) Patent Application Publication
(10) Pub. No.: US 2007/0182713 A1
(43) Pub. Date: Aug. 9, 2007

(54) Device and method for spatial orientation

(76) Inventor: Yefim Kereth, Rehovot (IL)

Correspondence Address: STETINA BRUNDA GARRED & BRUCKER, 75 ENTERPRISE, SUITE 250, ALISO VIEJO, CA, 92656, US

(21) Appl. No.: 11/650,250

(22) Filed: Jan. 5, 2007

(30) Foreign Application Priority Data
Jan. 8, 2006 (IL) 173,006

(51) Int. Cl. G09G 5/08

(52) U.S. Cl. 345/161

(57) ABSTRACT

There is provided a device for displaying, navigating and editing of geographical and/or geometrical data and/or images, including a housing, a display of the data and/or images affixed on the housing, and a joystick mechanism controlling at least the x and y axes for navigating and/or editing the displayed data and/or images. A method for aiding in spatial orientation and for enabling accurate coordination and/or target/object location, is also provided.

### FIELD OF THE INVENTION

The present invention relates to a device and method for aiding in spatial orientation, and also, to a device and method for fixing or verifying a user's position, by providing geographical and/or geometrical data or databases to be correlated with an image of a target and/or location as viewed by the user by means of the device.

### BACKGROUND OF THE INVENTION

There is continued progress in the area of geographical mapping and data basis production. This progress is supported by rapidly growing computing power, more precise and compact, orientation sensors, e.g., digital compasses, laser range finders, inclinometers and the like, and better geographical and/or geometrical databases software management tools. The possibility of implementing sophisticated geographical and/or geometrical data and/or database applications in field conditions is becoming more practical. To allow field implementation of such capability, there is a need for simple and intuitive user interface (controls and display) with the above-mentioned data and/or databases and for a method of merging real images with the geographical and/or geometrical data and/or databases.

### DISCLOSURE OF THE INVENTION

It is therefore a broad object of the present invention to provide a simple and sensuous human machine interface (HMI) device for geographical and/or geometrical data and/or databases displays, navigation and editing, enabling the identification of targets and/or locations.

It is a further object of the present invention to provide a device for displaying geographical and/or geometrical data, which is integrated with electro-optical images to display a view correlated or superimposed with the data.

It is still a further object of the present invention to provide a method for enhancing accuracy of coordination and/or location determination by combining geographical and/or geometrical data with field viewing images.

In accordance with the present invention there is therefore provided a device for displaying, navigating and editing of geographical and/or geometrical data and/or images, comprising a housing, a display of said data and/or images affixed on said housing, and a joystick mechanism controlling at least the x and y axes for navigating and/or editing said displayed data and/or images.

The invention further provides a method for aiding in spatial orientation and for enabling accurate coordination and/or target/object location, comprising acquiring a real image of target/object or location area, and defining image or window compatible geometry.

Optionally, the method comprises displaying a computer-generated compatible view based on geographical and/or geometrical data of an acquired target/object or location area and superpositioning said compatible view and said image, adjusting at least one of said view or image to achieve best match and/or correlation by effecting relative movement, and verifying said target/object or location match and/or correlation in said area.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purpose of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic view of an HMI device for displaying geographical and/or geometrical database of objects and/or locations for viewing;

FIG. 2 is a schematic view of the HMI device of FIG. 1, in a displaced position;

FIG. 3 is a block diagram of the device of FIGS. 1 and 2, showing the functional aspects thereof;

FIG. 4 is a schematic view of an integrated device of FIG. 1 with an electro-optical sensor and measurement accessories;

FIG. 5 is a block diagram of the device of FIG. 4, showing the functional aspects thereof, and

FIG. 6 is a flow diagram illustrating the method of operation of the device of FIG. 4.

### DETAILED DESCRIPTION OF THE PREFERRED EMBODIMENTS

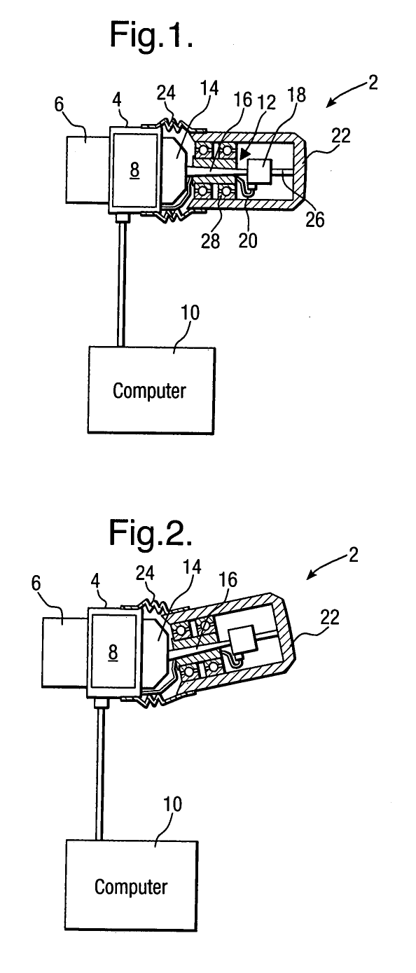

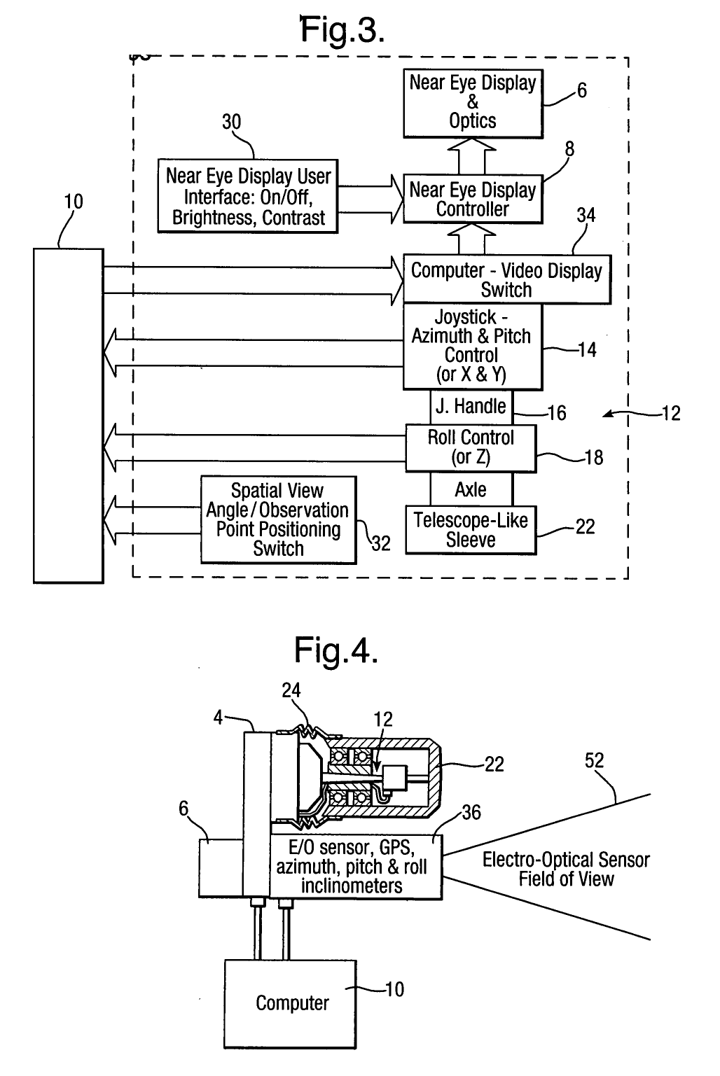

The HMI device for aiding a user in spatial orientation and for enabling accurate mutual coordination of two or more observers of target/object location, specifically, locating or verifying the user's position, according to the present invention, is illustrated in FIG. 1. As seen, the preferred embodiment of the HMI device 2 includes a housing 4 to which there is attached a display 6, e.g., a near-eye display. The housing 4 optionally encloses a controller 8, electronically, operationally connected to a computer 10. Advantageously, on the opposite side of the near-eye display 6, there is affixed on the housing 4 a joystick mechanism 12 having a stationary part 14 and a moveable stick 16. Optionally, there is attached to the free end of the stick 16 a roll control 18 enabling controlling, in addition to the x and y-axes and azimuth and pitch angles, also the z-axis movement, the roll angle and field-of-view/scale of the viewed and/or displayed databased objects or location display. Also seen is the wire 20 leading from the roll control 18 to the computer 10. Conveniently, there is provided a manipulatable sleeve 22, indirectly attached to the housing 4 by a flexible bellows 24. The roll control 18 is concentrically connected by a rod 26 to the interior surface of the sleeve 22, and there are further provided ball bearings 28, concentrically affixed between the stick 16 and the interior of the sleeve 22. This arrangement of the joystick mechanism 12 facilitates two-dimensional movement of the stick and concentric rotation of the sleeve about the axis of the stick, thus controlling the spatial viewing angle and/or spatial viewing point location and/or spatial field-of-view/scale of the databased objects and/or locations displayed. For example, as seen in FIG. 2, the sleeve 22 is displaced about its stationary part 14, causing a corresponding displacement or rotation of the viewable and selectably displayable database region. For simplicity, there is not shown in FIGS. 1 and 2, but only in FIG. 3, an ON/OFF brightness and contrast controller 30, and likewise, a spatial view angle/observation point positioning switch 32, and a computer display signal/video signal switch 34. Alternatively, the manipulatable sleeve 22 can be mounted on a spherical joint while interacting with an integrated joystick or with at least two separately integrated angular controllers (not shown). Configuration of separately integrated angular controllers located on the peripheral of the spherical joint, can provide additional space for packaging of components within the sleeve interior.

The operation of the device 2 will now be described also with reference to FIG. 3. Similar to an HMI of commonly used telescopes, the portable HMI device 2 is intuitive and/or sensuous and simple to operate. The azimuth, pitch and roll view angles of the device are controlled by a three-dimensional joystick mechanism 12, incorporated in a telescope-like sleeve 22. The complementary roll angle is controlled by the roll control 18, incorporated on the centre line of the telescope-like sleeve 22, which is capable of rotating around its own axis. This configuration of the controls is fully analogous to the spatial view angle control of hand-held telescopes and to the field-of-view adjustment for image magnification of the telescopes.

The observation point positioning (x, y and z) in the “virtual world” geographical and/or geometrical databases, can be controlled either by switching the special view angle controls to control the observation point positioning, or by other additional set of dedicated controls for the observation point positioning only.

The device 2 can be operated in a hand-held mode when standing alone or when attached to any hand-held electro-optical sensor or target acquisition system (TAS), or in a mounted mode, whenever attached to the HMI of an external sensor, as an HMI aid for a geographical and/or geometrical synchronized databases viewer.

The device 2 in its basic configuration, upon being interfaced with the computer 10 containing geographical and/or geometrical data/databases and data/databases management application, allows the exploration of the geographical and/or geometrical data/databases and models from different observation points in the space by three dimensional movement of the observations points with adjustable spatial view angles (azimuth, pitch and roll), and with adjustable field-of-view/scale relative to the database target, objects and locations.

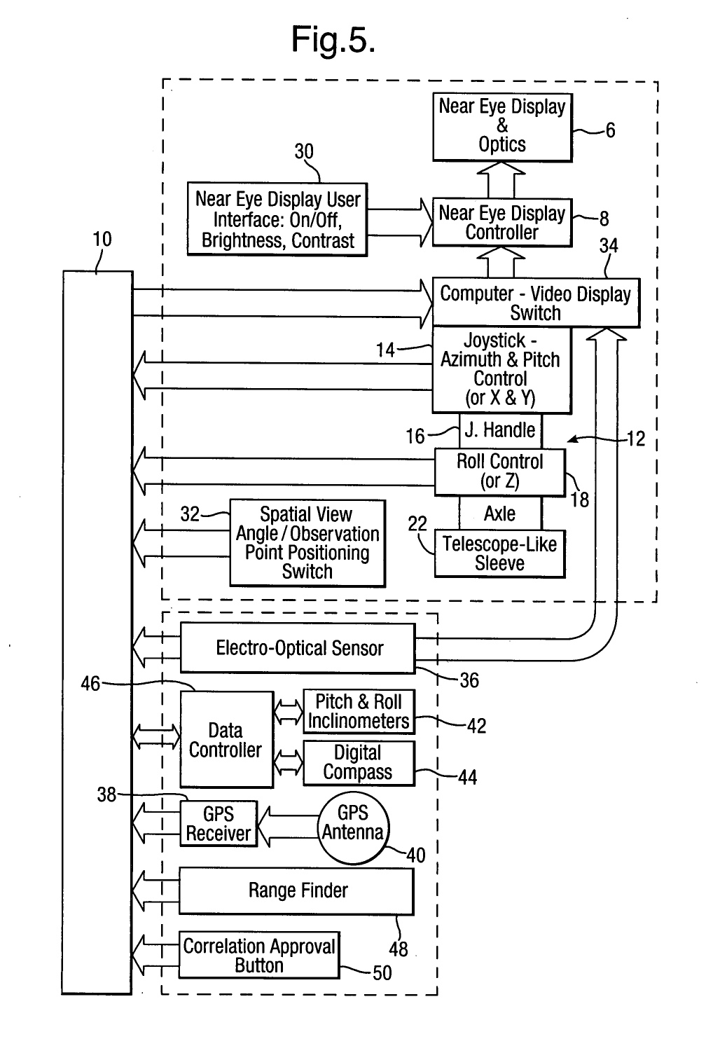

FIGS. 4 and 5 illustrate an embodiment of the device 2 of FIG. 1 integrated with an electro-optical sensor 36 and advantageously also equipped with ground-positioning system capabilities, e.g., a GPS, by means of a GPS receiver 38 having an antenna 40, pitch and roll inclinometers 42, a digital compass 44, a data controller 46 interfaced between the inclinometers 42, the compass 44 and the computer 10. In addition, there may be provided a laser range finder 48, e.g., a range finder, and a correlation approval button 50, the nature of which will be described hereinafter.

As seen in FIG. 4, optionally, the near-eye display 6 and sensor 36 are parallel so that the user aiming at a specific target/object within the field-of-view 52 looks into the near-eye display 6 aligned with the same direction. The image of the electro-optical sensor 36 is continuously sampled by the computer 10. Azimuth, pitch, roll, GPS and range data provide the computer 10 with data concerning its initial observation point positioning, spatial view angle and target location. At least a relevant part of the image of the electro-optical sensor 36 is attributed to the geometry, namely, the plane within given boundaries at the target location, to enable coordination of other observers. To achieve higher accuracy of coordination and/or to enable more accurate target location, the view of the geographical and/or geometrical data/databases and the image of electro-optical sensor 36, are co-ordinately overlaid by the computer 10, and displayed on the display 6. Due to the inaccuracies of azimuth, pitch, roll, and GPS sensors, it may be necessary to provide final corrections needed to make the database view meaningful for the observer. The corrections are effected by movement and rotation of sleeve 22, which are transferred to the joystick mechanism 12. Whenever there is a need to correct the observation point positioning, all of the controls of the joystick mechanism switched by a spatial view angle/observation point positioning switch 32, control the positioning in the geographical and/or geometrical data/databases. Once the required correlation or superpositioning is achieved, the observer can push the correlation approval button 50, to attribute part of the electro-optical image to the specific surface of the targeted object or area of the geographical and/or geometrical data/database. After achieving matching or correlation, it can be dynamically kept up to a certain level around the original target/object or area, based on image processing capabilities of the computer's software. When the device 2 is also equipped with a range finder 48, an additional parameter can be introduced for verifying a target/object location and for reducing the database space-of-interest boundaries.

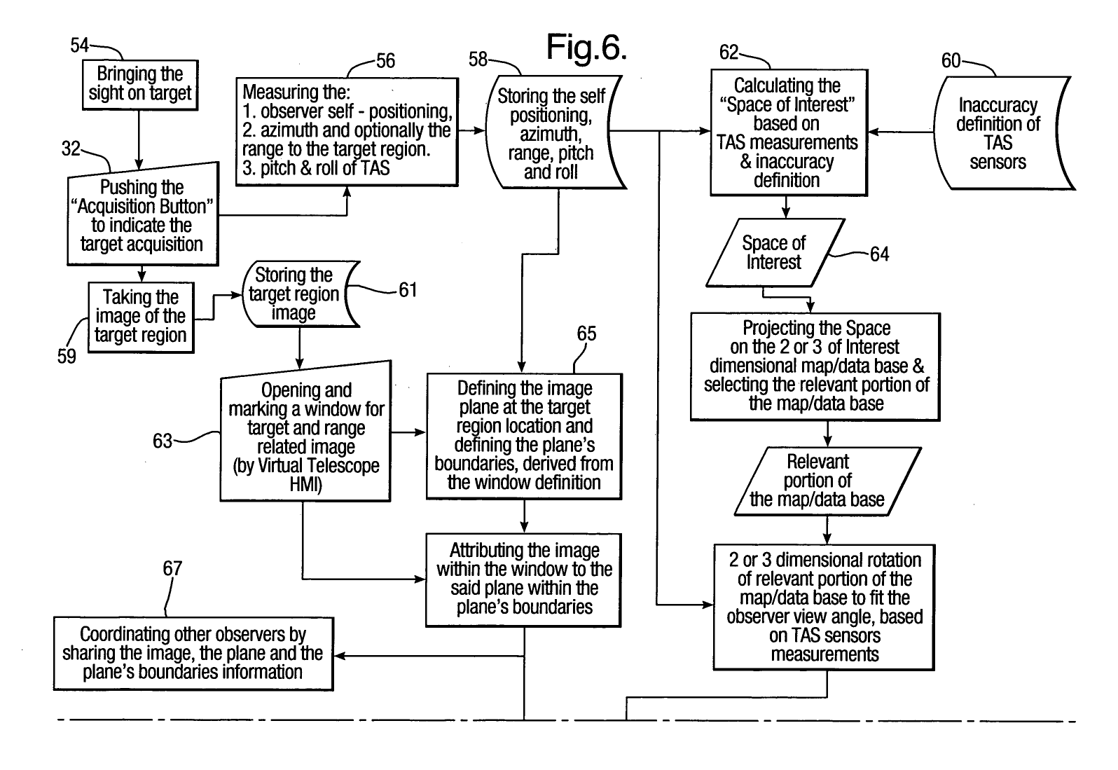

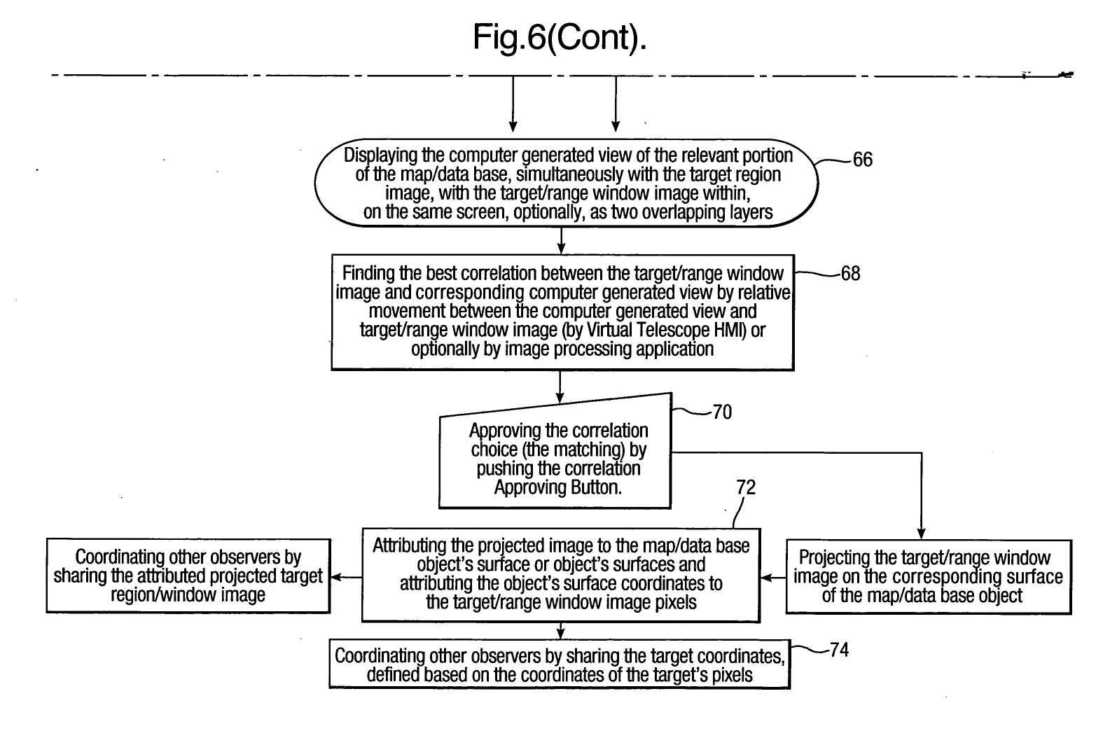

The method of utilizing the device 2 of FIG. 4 will now be described also with reference to FIGS. 5 and 6. The initial stage of the method is to aim the sensor 36 on the object, target or location 54. Then, by actuating the acquisition switch 32, indication for target acquisition, is provided. The indication triggers the measurement 56 and storage 58 of self-positioning, range, azimuth, pitch and roll of a device, and simultaneously, the sampling 59 and storage 61 of the electro-optical sensor's image of the target region. Thereafter, optionally, the observer opening and marking a window, at 63, for a target/range-related part of the image and correspondingly, the device, either automatically or with a user assistance, defines, at 65, the window compatible geometry at the target location, namely, the plane and its boundaries, to which the sensor's image or the image within the window will be attributed. Coordination with other observers, at 67, can be achieved by sharing the image and the related geometry data at the target location. Based on the measurements at 58 and the inaccuracy definition of the measurement accessories 60, the boundaries of the space-of-interest of the database are calculated at 62. The database within the boundaries of the space-of-interest 64 is then processed to build a view that fits the observer's location, spatial view angle and electro-optical sensor field-of-view angle 52, or, the target/range-related window, if opened, based on the device accessories measurements, including GPS and based on electro-optical sensor 36 specifications. Thereafter, the “real world” image provided by the electro-optical sensor 36 and the view generated by the database management application are simultaneously displayed, at 66, on display 6 in two, advantageously overlapping layers, mainly, being super-positioned. To find the best match or correlation between the real world target region image and computer-generated view, software-based image processing and/or manual adjustment, can be applied 68. The manual adjustment is done by moving the computer-generated display layer relative to the electro-optical sensor 36 target region imaged layer. Once matching is achieved and approved 70, the target region image can be projected on the corresponding surface of the database object or area, and a relevant portion thereof within the object's or area's surface boundaries, can be attributed at 72 to the geographical/geometrical database, and optionally, the geographical/geometrical coordinates can be attributed to the real image pixels. The visually enhanced database can then be used to enable, at 74, other observers using the database, to obtain high accuracy coordination of the targets and locations in the field.

In order to facilitate matching/correlation process, the database of the object's/area's surfaces may be presented without the artificial database texture, thus allowing the real world image to be applied complimentary to the object's/area's surfaces.

Whenever a three-dimensional database is not available, two-dimensional aerial pictures can be upgraded to serve the above-described method. The upgrading of the pictures can be done by converting the contour lines of the objects into vertical surfaces with defined or undefined heights.

The above method allows an observer accurate location of field targets and/or objects and allows other observers using the same enhanced database to create accurate coordination among themselves.

The device and the method are useful for a broad range of indoor, outdoor and field applications.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A device for displaying, navigating and editing of geographical and/or geometrical data and/or images, comprising:
a housing;
a display of said data and/or images affixed on said housing, and
a joystick mechanism controlling at least the x and y axes for navigating and/or editing said displayed data and/or images.

2. The device as claimed in claim 1, further comprising a controller enclosed in said housing.

3. The device as claimed in claim 2, further comprising a computer operationally connected to said controller.

4. The device as claimed in claim 1, wherein said joystick mechanism controls the spatial viewing angle by azimuth, pitch and roll angles adjustment.

5. The device as claimed in claim 1, wherein said joystick mechanism includes a base affixed to said housing and a manipulatable stick protruding therefrom.

6. The device as claimed in claim 5, further comprising a roll-angle, z-axis, field-of-view/scale control mounted on said stick.

7. The device as claimed in claim 1, further comprising a sleeve indirectly attached to said housing by a flexible bellows or by a spherical joint member allowing its rotation about the x, y, and optionally, the z axes.

8. The device as claimed in claim 7, wherein said sleeve and spherical joint member interact with at least two separately integrated angular controllers creating a joystick mechanism for controlling at least the x and y axis.

9. The device as claimed in claim 4, wherein said roll-angle control, also controlling the z-axis and field-of-view/scale, is attached to the interior surface of said sleeve.

10. The device as claimed in claim 5, wherein said sleeve is coupled to said stick by ball bearings.

11. The device as claimed in claim 8, wherein said joystick mechanism is hollow and encloses said housing and components therein.

12. The device as claimed in claim 1, further comprising an electro-optical sensor operationally connected to said computer, mounted on said housing.

13. The device as claimed in claim 12, wherein said sensor is mounted on the side of the housing opposite to said display.

14. The device as claimed in claim 1, further comprising a digital magnetic compass, pitch and roll inclinometers operationally connected through a data controller to said computer.

15. The device as claimed in claim 1, further comprising a GPS receiver including an antenna operationally connected to said computer.

16. The device as claimed in claim 1, further comprising a range finder operationally connected to said computer.

17. A method for aiding in spatial orientation and for enabling accurate coordination and/or target/object location, comprising:
acquiring a real image of a target object or location area, and
defining image or window compatible geometry at the target location and attributing at least a part of the image to said geometry.

18. The method as claimed in claim 17, wherein after acquiring a real image of target/object or location area, the method further comprising marking a window for a target/range-related part of the image.

19. The method as claimed in claim 17, wherein said data is displayed on a device for displaying, navigating and editing of geographical and/or geometrical data and/or images.

20. The method as claimed in claim 19, wherein said device's display and imaging sensor are parallel facilitating convenient aiming of said device at a selected target/object or location.

21. The method as claimed in claim 17, further comprising displaying a computer-generated compatible view based on geographical and/or geometrical data of an acquired target/object or location area.

22. The method as claimed in claim 21, further comprising displaying and superpositioning said compatible view and said image, adjusting at least one of said view or image to achieve best match and/or correlation by effecting relative movement, and verifying said target/object or location match and/or correlation in said area.

23. The method as claimed in claim 17, further comprising acquiring ground positioning data for determining the user's observation point of said target/object or location.

24. The method as claimed in claim 17, further comprising a range locator for determining the location of said target or object.

25. The method as claimed in claim 19, wherein said device further comprises an azimuth finder, pitch and roll inclinometers for effecting adjustment of the spatial viewing angle.

26. The method as claimed in claim 19, wherein said device includes a three-dimensional joystick mechanism and the relative movement and rotation are effected by manipulation of said joystick.
